(19) United States
(12) Patent Application Publication
(10) Pub. No.: US 2025/0341393 A1
(43) Pub. Date: Nov. 6, 2025

(54) POLYMERIC ELECTROLYTIC TILT SENSOR AND METHOD FOR MAKING THE SAME

(71) Applicant: The Fredricks Company, Huntingdon Valley, PA (US)

(72) Inventors: Giovanni DeLuca, Hatboro, PA (US); Jalpen Patel, Yardley, PA (US)

(21) Appl. No.: 18/653,141

(22) Filed: May 2, 2024

(51) Int. Cl. G01C 9/18

(52) U.S. Cl. CPC G01C 9/18; G01C 2009/182

(57) ABSTRACT

An electrolytic tilt sensor and a method of forming the tilt sensor. The tilt sensor includes a containment envelope integrally fabricated from a polymer material having at least three apertures formed therein, electrodes extending from outside of the envelope into the containment envelope, and partially filled with an electrolyte solution. The method of forming the tilt sensor includes the steps of molding the polymer containment envelope having a cap and a header, partially filling the cap with the electrolytic solution through the opening within the cap, and hermetically sealing the header to the cap.

### TECHNICAL FIELD

The present invention relates generally to electrochemical devices and, in particular, to an electrolytic tilt sensor and a method for making same.

### BACKGROUND OF THE INVENTION

Electrolytic tilt sensors include devices that provide output signals proportional to the angle of tilt and/or the direction of tilt when included as part of an appropriate electrical circuit. Tilt sensors were originally developed for weapons delivery and aircraft navigation and are now used in applications such as oil drilling, construction laser systems, automotive wheel alignment, seismic and geophysical monitoring, virtual reality systems, and robotic manipulators.

Most conventional electrolytic tilt sensors generally comprise a housing, or envelope, made of a non-conductive material, such as glass; or, as previously disclosed in U.S. Pat. No. 6,249,984 B1, of metal. The envelope is partially filled with an electrolytic solution and encloses a plurality of electrodes, which are partially immersed in the electrolytic solution when the tilt sensor is in its upright (i.e., zero tilt or electrical null) position. One of the electrodes, typically a center electrode, is a common electrode, and the remaining electrodes are sensing electrodes, which are typically grouped in one or more pairs that define one or more distinct tilt axes in conjunction with the center common electrode.

As the tilt sensor is tilted with respect to the horizontal axis, the surface of the solution remains horizontally leveled which causes each of the sensing electrodes to become more or less immersed in the electrolytic solution. The increase or decrease in immersion results in a corresponding change in impedance between any one of the sensing electrodes and the common electrode. This impedance change is measured by an electrical circuit and correlated to a tilt angle and/or tilt direction, depending on the number of sensing electrodes and the type of electrical circuit being used.

A shortcoming of glass-enclosed tilt sensors is that they are relatively fragile due to their glass construction. Glass-enclosed sensors must be handled with care and protected in special containment packages. They are costly to manufacture and generally use precious metal electrodes. Moreover, glass enclosed sensors may not be suitable for certain applications where a tilt sensor having a more robust enclosure is required. Glass-enclosed sensors may also increase in cost depending on the complexity of the shape of the sensor and said shapes may be limited by the glass material.

A shortcoming of metal-enclosed tilt sensors is that they are limited in terms of compatibility with the electrolyte solution. Generally, metal-enclosed tilt sensors experience corrosion based on the electrolytic solution that is used. Further, these types of tilt sensors have a higher surface energy which can result in a meniscus effect and further effect repeatability. Metal enclosures also require post processes such as plating and cleaning which can add to the cost of manufacturing the sensor. More complex tilt sensor shapes can also increase cost. Similar to glass-enclosed sensors, manufacturing costs of metal enclosures can also increase depending on the complexity of the shape of the sensor and may also be limited in shape based on the metal material. Thus, there is a need for a tilt sensor having a polymer envelope.

### SUMMARY OF THE INVENTION

The present invention comprises an electrolytic tilt sensor that includes a polymer containment envelope having at least three apertures formed therein. The interior of the envelope defines a chamber, which is partially filled with an electrolytic solution. At least two electrodes are provided. Each electrode has an electrically active portion located within the chamber and a lead portion extending to the exterior of the envelope through a corresponding one of the apertures.

In another aspect, the present invention comprises an electrolytic tilt sensor that includes a containment envelope defining a chamber, a longitudinal axis, and five apertures located in the envelope. The apertures are arranged in quadrature around the longitudinal axis. The containment envelope includes a first polymer member having an opening therein and a second polymer member sealingly engaging the opening in the first member. The chamber is partially filled with an electrolytic solution. The tilt sensor includes four electrodes, each electrode having an electrically active portion located within the chamber in parallel relationship with the longitudinal axis and a lead portion extending to the exterior of the envelope through a separate one of the apertures.

In yet another aspect, the present invention comprises an electrolytic tilt sensor that includes a containment envelope defining a chamber, a longitudinal axis, and three apertures located in the envelope. The apertures are spaced apart from one another and share a common axis. The containment envelope includes a first polymer member having an opening therein and a second polymer member sealingly engaging the opening in the first member. The chamber is partially filled with an electrolytic solution. The tilt sensor includes three electrodes, each electrode having an electrically active portion located within the chamber in parallel relationship with the longitudinal axis and a lead portion extending to the exterior of the envelope through a separate one of the apertures.

Use of a polymer to integrally fabricate an electrolytic tilt sensor advantageously lowers surface energy for meniscus inhibition which can, in turn, improve repeatability and accuracy transmitted by the tilt sensor. Another advantage is that the polymeric electrolytic tilt sensor presently described can also have a higher chemical and corrosive resistance, leading to a wider range of compatibility with the electrolyte solution and improving lifetime. Yet another advantage is the improvement in lead time based on the availability of polymers and improved manufacturing costs as compared to metal and glass materials.

In yet another aspect, the invention comprises a method of assembling an electrolytic tilt sensor. The method includes providing a polymer cap having an opening and interior surfaces defining a containment volume, providing a polymer header, and providing an electrolytic solution. The containment volume is partially filled through the opening of the cap with the electrolytic solution and the header is subsequently sealingly engaged with said opening.

These fabrication methods allow for novel geometries to be formed which can further improve repeatability. Other improvements in fabricating novel geometries allow for optimized fluid flow, improved linear range, and improved response time.

The polymeric electrolytic tilt sensor (PETS) can be fabricated via injection molding, computer numerical control (CNC) machining, or 3D printing. The polymer materials, of which are further described below, can be formed into novel geometries which can be expensive to form out of metal or glass. Further, new features can be incorporated into existing geometries for optimized operations.

Another aspect of the invention is an improvement to the electrolyte solution by using functional materials within the solution for improving performance and lifetime of an electrolytic tilt sensor. The functional materials to be used are at least one, or a combination, of a rare earth metal salt, anionic surfactant, hydrotrope, and non-ionic surfactant in which the former three functional materials used to drive the conductivity, as well as inhibit corrosion and prolong the lifetime of the electrolytic tilt sensor. The solubility of the non-ionic surfactant can be improved when in combination with a hydrotrope. An advantage of a combination of anionic and non-ionic surfactants is a lower surface tension resulting in reduced meniscus formation, improving the wettability of the solution, and remaining foam free from the selected defoaming agent. Overall, a mixture of any of these functional materials improves the performance, extends the range, and improves repeatability; all without exhaustive processing.

### BRIEF DESCRIPTION OF THE DRAWINGS

The present invention will be described in greater detail with reference to the accompanying drawings in which,

FIG. 1 is a perspective view illustrating an electrolytic tilt sensor according to the present invention,

FIG. 2 is a bottom perspective view of the electrolytic tilt sensor shown in FIG. 1,

FIG. 3 is a perspective view of a cross-section of the electrolytic tilt sensor taken along line 3-3 of FIG. 1,

FIG. 3A is an exploded view of a cross-section the electrolytic tilt sensor shown in FIG. 3,

FIG. 4 is a perspective view of a cross-section of the electrolytic tilt sensor taken along line 4-4 of FIG. 1,

FIG. 5 is a perspective view illustrating an alternative embodiment of the electrolytic tilt sensor according to the present invention,

FIG. 6 is a bottom perspective view of the electrolytic tilt sensor shown in FIG. 5,

FIG. 7 is a perspective view of a cross-section of the electrolytic tilt sensor taken along line 7-7 of FIG. 5,

FIG. 8 is a perspective view of a cross-section of the electrolytic tilt sensor taken along line 8-8 of FIG. 5,

FIG. 9 is a perspective view illustrating an alternative embodiment of the electrolytic tilt sensor according to the present invention,

FIG. 10 is a perspective view illustrating an alternative embodiment of the electrolytic tilt sensor according to the present invention,

FIG. 11 is a perspective view illustrating an alternative embodiment of the electrolytic tilt sensor according to the present invention,

FIG. 12 is a perspective view illustrating an alternative embodiment of the electrolytic tilt sensor according to the present invention,

FIG. 13 is a perspective view illustrating an alternative embodiment of the electrolytic tilt sensor according to the present invention, and

FIG. 14 is a perspective view illustrating an alternative embodiment of the electrolytic tilt sensor according to the present invention.

FIG. 15 is a perspective view of a cross-section of the electrolytic tilt sensor taken along line 15-15 in FIG. 14.

### DESCRIPTION OF THE PREFERRED EMBODIMENTS

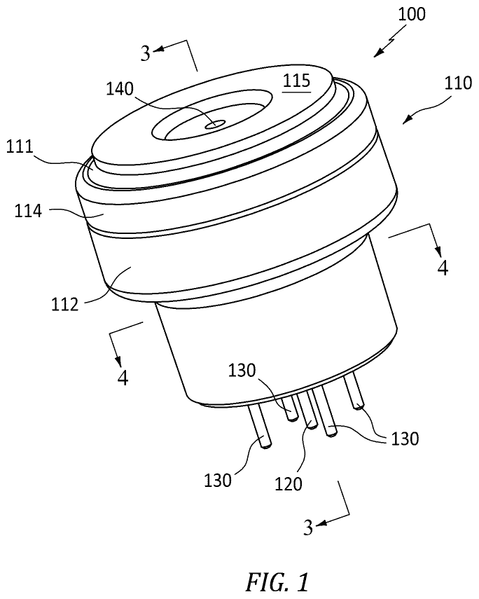

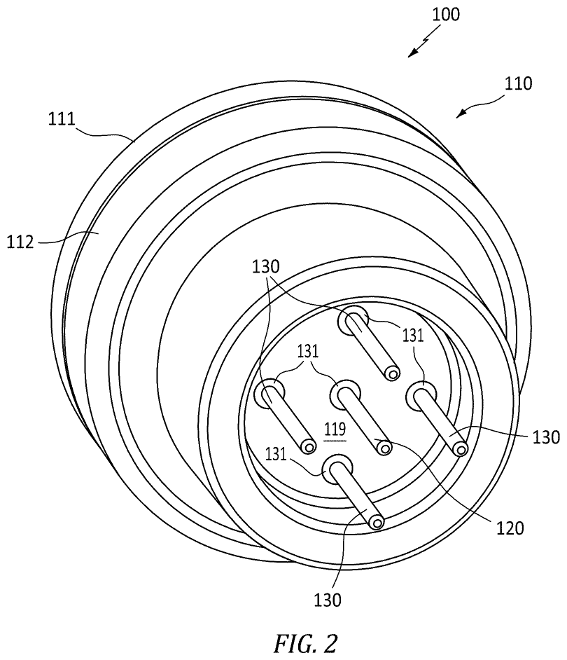

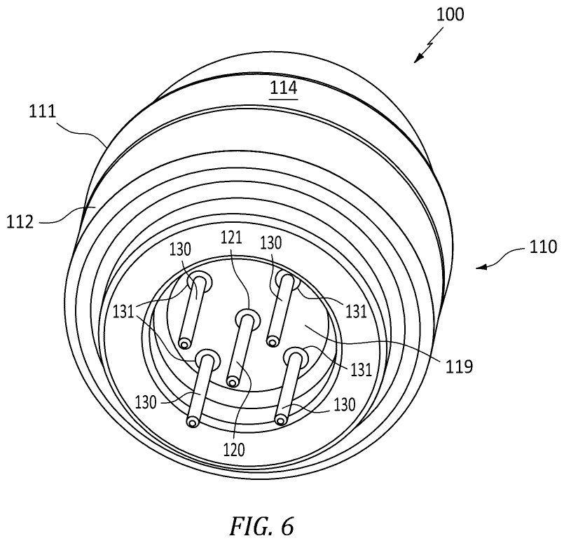

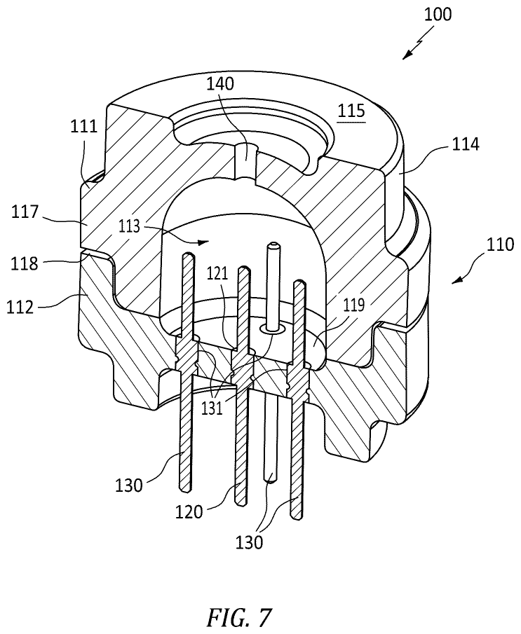

Referring to the drawings, wherein like numerals indicate like elements, FIGS. 1-8 illustrate an electrolytic tilt sensor, which is designated generally by the numeral 100. The tilt sensor 100 comprises a containment assembly 110 having a generally cylindrical shape. While a cylindrical shape is depicted, other geometries are contemplated as an advantage of the polymer material is that novel geometries can be formed. The containment assembly 110 of the present embodiment includes a polymer cap 111 and a polymer header 112, both of which are integral formed as opposed to a cap or header formed from a different material and coated with a polymer. Either the containment assembly 110, or a part thereof 111, 112 is molded exclusively from polymer. While the preferred embodiment of the polymeric electrolytic tilt sensor 100 is an integral fiber-reinforced polymer composite such as glass fiber reinforced liquid crystal polymer composite (GF/LCP), one skilled in the art would understand any polymer can be used, such as, but not limited to, organic polymers, piezoelectric polymers, conductive polymers, and/or high-performance polymers. The polymer materials are selected based on their compatibility with electrolyte solutions, impermeability, flame retardancy, availability, low moisture absorption, dimensional stability, mechanical strength, hardness, temperature stability, and ability to maintain a leak-tight seal or ultrasonic weld. The polymer cap 111 and header 112 define a chamber 113, which is partially filled with an electrolytic solution. Additionally, the cap 111 and header 112 can be made of different polymers. The cap 111 and header 112 are secured together by welding, which is described in more detail below.

A plurality of pin-type electrodes 120, 130 extend from outside the containment assembly 110 into the chamber 113 through a plurality of apertures 121, 131 in the header 112. The portions of the electrodes 120, 130 outside the containment assembly 110 are terminal portions for connecting the tilt sensor to an appropriate electrical circuit. The portions of the electrodes 120, 130 inside the containment assembly 110 are electrically conductive portions that are subject to immersion in the contained electrolytic solution. A further advantage of fabricating a tilt sensor 100 from a polymer material is that it is non-conductive, unlike a tilt sensor molded from metal, of which a tilt sensor machined from metal would require insulators isolating the electrodes 120, 130.

The polymer cap 111 has a side wall 114 and a top wall 115 attached to or integral with the upper end of the side wall 114. It is preferred that the side wall 114 forms a cylindrical tube and the top wall 115 is planar and formed integral with the side wall 114. However, the side wall may be another shape, such as rectangular or other axially symmetric shape, and the top wall may have another shape such as arcuate, or the like. As shown, for example, in FIG. 1, the top wall 115 can form an annual, concentric extension above the cylindrical side wall 114. The lower end of the side wall 114 defines an opening 116 in the polymer cap 111 and terminates at a protruding lip or flange 117, although it is preferred to provide a flange to facilitate attaching the header to the cap, it need not be provided. The polymer material chosen, in combination with a selected geometry, is based on their ability to reduce meniscus formation by the electrolyte solution, which would effectively provide a more accurate reading from the tilt sensor 100 when in use. One skilled in the art would choose said material and geometry based on its ability to reduce surface energy.

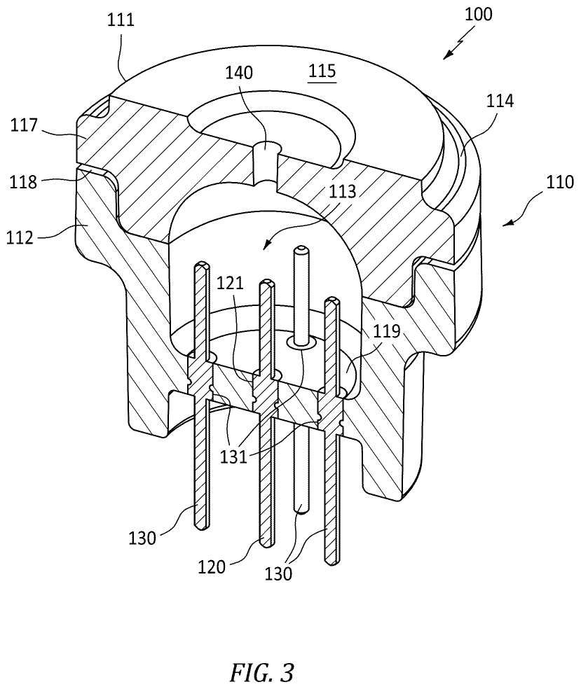

The header 112 comprises a planar disc 119 integrally molded to and having a flange 118 around its outer periphery. In a preferred embodiment, the header 112 is formed from the same polymer material as the polymer cap 111, although the header 112 and cap 111 need not be formed from the same polymer, or by the same method of formation. As shown in FIG. 3, the outer periphery of the disc 119 engages the inner periphery of the side wall 114 and the upper surface of the flange 118 of the header 112 engages the lower surface of the flange 117 of the cap 111. As can be seen, these flanges 117,118 form surfaces that complementarily mate with each other, by way of tongue and groove energy directors, from the outer periphery to the inner chamber 116 defined by the polymer cap 111 and header 112 when joined via ultra-sonic welding techniques. While a tongue and groove energy directors are presently described, other points of contact between the polymer cap and header are contemplated.

A hermetic, continuous seal is provided at the interface between the two flanges 117, 118, preferably by welding. The preferred method of welding the flanges 117, 118 to one another is by way of ultrasonic welding. Other methods of welding polymer material such as laser welding, hot gas welding, hot plate welding, spin welding, and vibration welding are contemplated, as well as non-welding alternatives such as adhesives. Other techniques, such as employing a shear weld design, can be used to increase the strength of the weld.

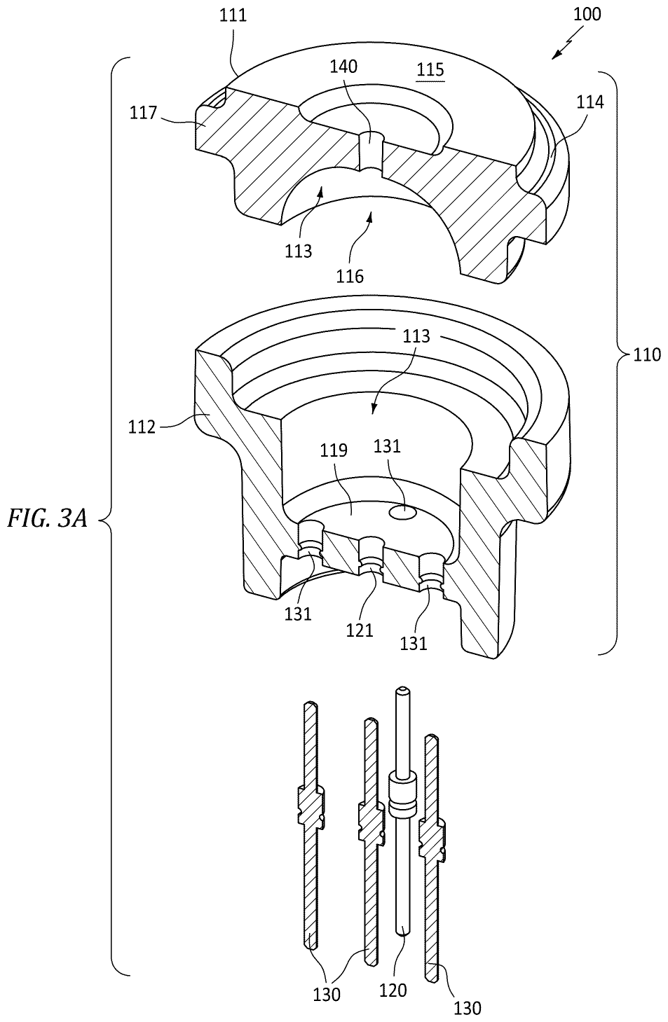

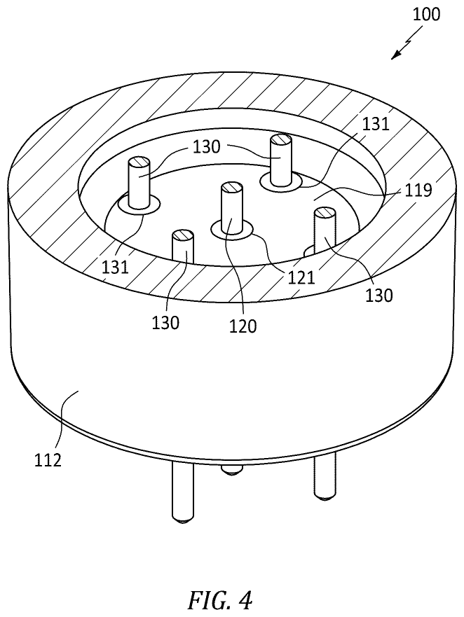

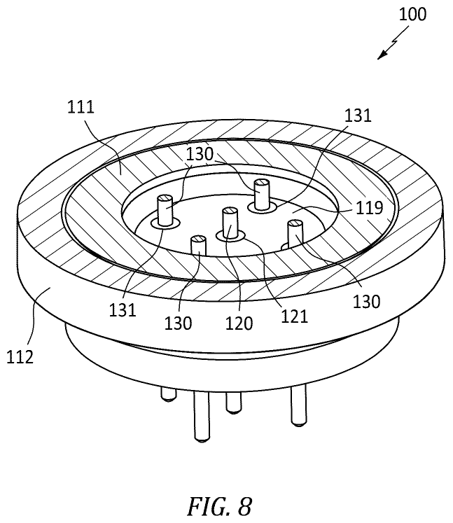

As best seen in FIGS. 4 and 8, the header 112 includes five apertures 121, 131 that receive the electrodes 120, 130 in a dual axis electrolytic tilt sensor. Four of the apertures 131, for the sensing electrodes 130, are arranged in quadrature around the center of the header 112. The fifth aperture 121, for the center common conductor 120, is located at the center of the header 112. Although five apertures are indicated for accommodating five electrodes, more or fewer apertures may be provided depending on the number of pin-type electrodes used. In an alternative embodiment of the present invention, the apertures may be located in the upper wall of the cap instead of the header. However, the header would still be attached to the cap as described above, preferably by ultrasonic welding.

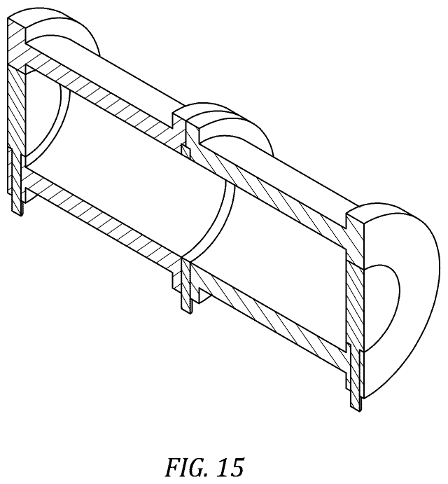

In a dual axis electrolytic tilt sensor, the pin-type electrodes 120, 130 include a center common electrode 120 and two pairs of spaced apart sensing electrodes 130. The electrodes 130 in each sensing conductor pair are located at diametrically opposite locations relative to the center electrode 120 and define a distinct tilt axis with the common electrode 120. The number and arrangement of the electrodes are design variables that are known and would be selected by those skilled in the art. For example, in a single axis tilt sensor, the pin-type electrodes 120, 130 include a center common electrode 120 and only one pair of spaced apart sensing electrodes 130. In another example, a roll independent single axis tilt sensor as illustrated in FIG. 14 may have electrodes arranged similar to that of a single axis tilt sensor, but the portion of the electrodes that are disposed within the containment assembly 110 are cylindrical in shape, with the common electrode 120 being hollow to allow the electrolyte solution to pass through it, and the sensing electrodes 130 act as a type of cap on either end of the containment assembly 110, as seen in FIG. 15. Other variations as to the number, shape, and arrangement of electrodes are contemplated. Although a single axis tilt sensor and a dual axis tilt sensor are presently disclosed having three and five electrodes 120 respectively, more than five electrodes can be used for varying tilt sensing directions on multiple planes.

The sensing electrodes 130 are preferably arranged in quadrature about the center axis of the chamber, and the common electrode 120 is preferably located at the center axis. Being located in quadrature, the two pairs of diametrically opposed electrodes define two orthogonal tilt axes, for example, Cartesian X and Y axes. In this configuration, the output voltages of the sensing electrodes are measured and correlated to one another to provide the angle of tilt regardless of direction. In addition, if a direction reference is established, the output voltages may be further used to determine the direction of tilt.

The preferred electrodes are the pin-type electrodes shown. However, other types of electrodes, such as ones having pin-type electrically active portions and flexible wire terminal portions may be used. Moreover, the electrically active portions may be other than pin shaped to suit a particular application of the tilt sensor 100. For example, the electrically active portions may be arcuate, coiled, meandering, or the like. Also, the terminal portions may comprise strips, braids, foils, or the like. Preferably, the electrodes are made from either nickel or copper, and alloys thereof, and can be coated with metals, such as tin, gold, silver, nickel, and electroless nickel.

The polymeric electrolytic tilt sensor 100 can be fabricated through a variety of methods, such as injection molding, computer numerical control (CNC) machining, and additive manufacturing processes. In a preferred method, the polymer cap 111 is molded from a polymer by way of injection molding, allowing for various complex shapes. During molding of the polymer header 112, the electrodes 120, 130 can either be insert molded, over molded, pressed, or deposited with various methods for surface mounting, such that the electrodes 120, 130 are secured in place. Alternatively, the electrodes 120, 130 can be deposited, rather than inserted, by way of various surface mounting techniques such as chemical vapor deposition, evaporation, sputtering, and other electrochemical techniques. While a list of surface mounting techniques is provided, other methods of surface mounting can be used. In a preferred method, the electrodes 120,130 are over-molded in order to produce a strong bond between the pins and the surrounding polymer as well as to form a seal for the internal electrolytic fluid. As a secondary measure, the electrodes 120,130 can be further sealed with adhesive in the event the seal formed by over-molding is compromised. The polymer cap 111 is then partially filled with the electrolyte solution through an opening 116 located at the base of the polymer header 112. The polymer cap 111 and polymer header 112 are then combined and hermetically sealed by the methods described above and create a chamber 113 within the interior of the polymeric electrolytic tilt sensor 100. Preferably, the polymer cap 111 and the polymer header 112 are combined by way of ultrasonic welding, which causes the tongue and groove joint to collapse and fuse to form the hermetic seal. The method of forming the polymeric electrolytic tilt sensor 100 is not limited to the method of formation as described above, as other methods of formation, such as computer numerical control machining or additive manufacturing can be used. Further, the method is also not limited to the order described above, as, for example, the solution may be inserted after the polymer cap 111 and polymer header 112 are combined through a fill hole 140 located on the top wall 115. A combination of polymer formation methods can be employed for different components of the containment assembly 110.

The above-described process is a quick and efficient method of manufacturing an electrolytic tilt sensor according to the present invention. However, other methods of assembly may be used.

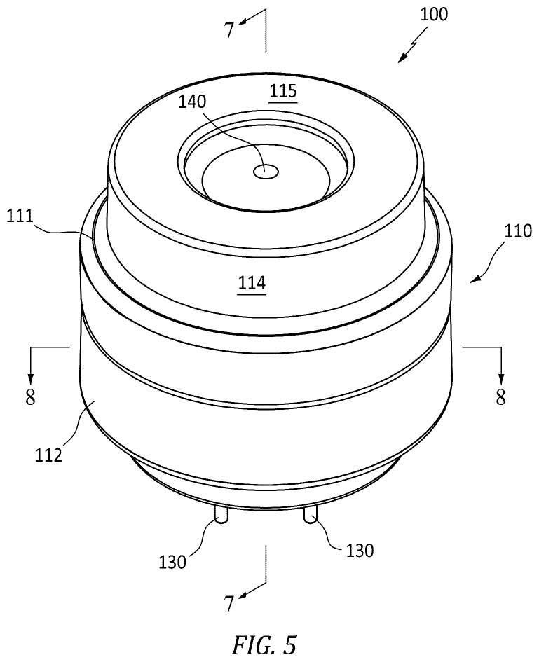

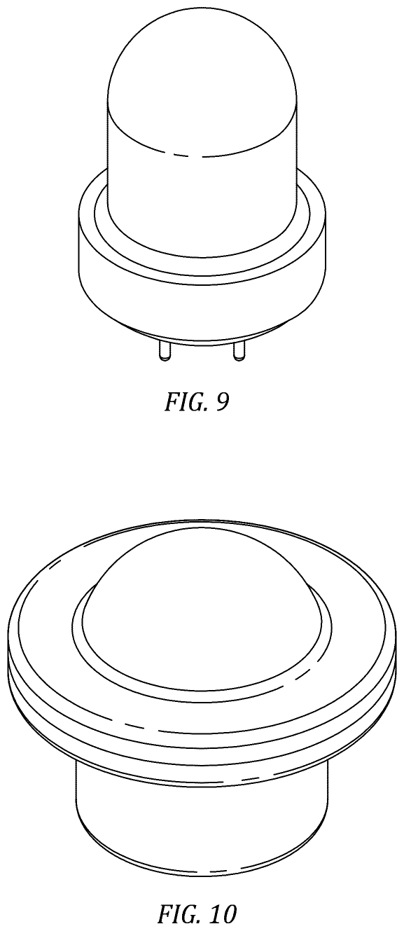

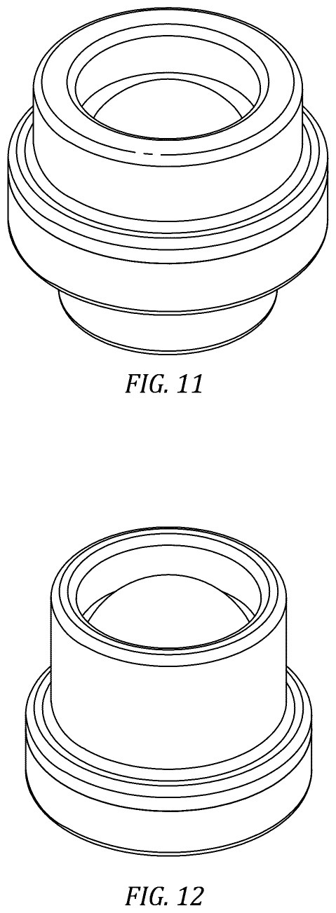

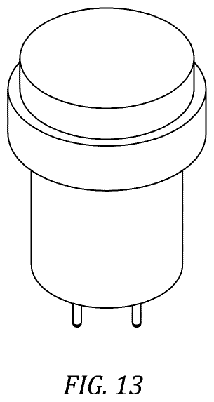

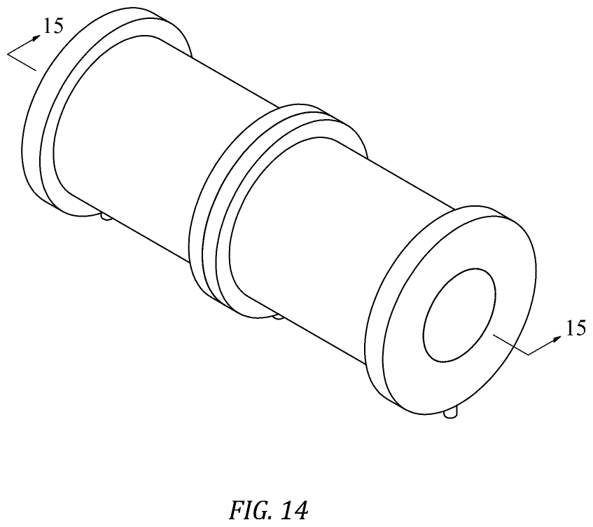

As previously described, a plurality of shapes can be formed using the methods above. For example, with reference to FIG. 1, the polymeric electrolytic tilt sensor 100 has an overall revolved “T” shape, with the welding point between the cap 111 and header 112, located towards the upper surface of the tilt sensor 100. Alternatively, FIG. 5 is similar in shape to that of FIG. 1, although the welding point is located towards the bottom surface of the tilt sensor 100 and the cap 111 has a top wall 115 that protrude more prominently, of which the diameter of the protrusion is smaller than that of entire tilt sensor 100. The chamber 113 of both present embodiments are the same general hemispherical shape, wherein the electrodes 120, 130 protrude from the bottom surface of the hemisphere through the header 112. Other shapes, such as the spherical shape of FIG. 9, the combination of a spherical shape with an outwardly protruding lip of FIG. 10, the combination of a spherical shape with an upwardly protruding lip of FIGS. 11 and 12, the cylindrical shape with an outwardly protruding lip of FIG. 13, and the cylindrical shape with a protruding collar located at each end of the cylinder as well as along the center of the cylinder of FIG. 14 are illustrated to demonstrate the variety, complexity, and numerosity of shapes that can be fabricated, of which different welding points are located as needed to best combine the respective caps 111 and headers 112. The polymeric electrolytic tilt sensor 100 is also not bound to substantially vertically biased shapes, as can best be seen by the cylindrical shape and structure of FIG. 14, in which the polymeric electrolytic tilt sensor 100 is vertically symmetrical, and the cap 111 and header 112 resemble one another. Further, chamber 113 can vary in shape to resemble a sphere or cylinder, as well as any other shape that would be appropriate given the overall shape of the tilt sensor 100. The overall diameter of the tilt sensor 100 is roughly 9 mm with an overall height of roughly 19 mm. The electrodes 120,130 have a length of preferably 5 mm and a diameter of 0.5 mm. While preferred shapes and dimensions are illustrated, other shapes can be molded to achieve better meniscus inhibition, optimized fluid flow, improved repeatability, increased linear range, and improved response time. Similarly, the dimensions of the electrodes are formed to be compatible with the component to which the tilt sensor would attach to but are in no way limited to the dimensions presently described.

Another aspect of the invention is an improvement to the electrolyte solution by using functional materials within the solution for improving performance and lifetime of an electrolytic tilt sensor. The electrolyte solution presently described can be used with the polymer electrolytic tilt sensor 100, or any other electrolytic tilt sensor, such as those composed of metal or glass. The solvent can be any polar solvent with a high dielectric constant capable of carrying a charge through dissolution of salts into ions. A preferred embodiment uses methanol, ethanol, or an ethanol/water mix, although other mediums are contemplated. The functional materials consist of a rare earth metal salt, an anionic surfactant, a hydrotrope, and a nonionic surfactant. All, one, or any mixture thereof can be used in the solution, apart from the non-ionic surfactant which would require one of the other three functional materials.

The rare earth metal salt acts as a corrosion inhibitor and provides synergism with the anionic and nonionic surfactants. The rare earth metal is selected from the group consisting of cerium salts, terbium salts, praseodymium salts, or a combination thereof, or a salt of a rare earth element in the tetravalent oxidation state, as well as salts including nitrates of yttrium, gadolinium, cerium, europium, terbium, samarium, neodymium, praseodymium, lanthanum, holmium, ytterbium, dysprosium, and erbium. Preferably, the solution would contain from about 0.01 to about 0.02 weight percent of rare earth metal.

The anionic surfactant acts as an anodic corrosion inhibitor, and further improves performance, repeatability, as well as reducing meniscus formation. Combining the anodic corrosion inhibiting properties of the anionic surfactants with a rare earth metal, such as cerium nitrate, results in a synergistic effect, producing a negative shift of the corrosion potential, and improving the lifetime of the electrolytic tilt sensor. The anionic surfactants are selected from the group consisting of alkoxylated hydrocarbyl carboxylate, sulfonate, sulfate and phosphate esters. Preferably, the solution would contain from about 0.01 to about 0.25 weight percent of anionic surfactant.

The hydrotrope acts to solubilize hydrophobic compounds to allow more concentrated formulation of surfactants. The hydrotrope is selected from the group consisting of monofunctional alcohols and polyfunctional alcohols, glycol compounds, glycolether compounds, polyfunctional organic alcohols, toluene sulfonates, xylene sulfonates, cumene sulfonates, octyl sulfonates, and mixtures thereof. Preferably, the solution would contain from about 0.025 to about 0.1 weight percent of hydrotrope.

Non-ionic surfactants solubility is improved by the hydrotrope. A combination of the anionic surfactants and non-ionic surfactants lower surface tension and improve wettability, as well as remaining foam free when a defoaming agent is added. The nonionic surfactant is selected from the group consisting of ethoxylated alkylphenols, ethoxylated aliphatic alcohols, ethoxylated amines, ethoxylated etheramines, carboxylic esters, carboxylic amides, polyoxyalkyleneoxide block-copolymers and alkylated alkylethoxylates. Preferably, the solution would contain from about 0.01 to about 0.025 weight percent of hydrotrope.

While preferred groups and weight percentages are described, those skilled in the art would understand that the any mixture of the group, compounds similar to that of the group, and varying weight percent can be used other than presently described. Materials can be used individually or any mixture thereof, although a preferred embodiment would comprise at least one of cerium nitrate, cerium acetate, sodium dodecylbenzene sulfonate, sodium lauryl ether sulfate, sodium xylene sulfonate, alcohol ethoxylate, or polydimethylsiloxane.

Although the invention has been described and illustrated with respect to the exemplary embodiment thereof, it should be understood by those skilled in the art that the foregoing and various other changes, omissions, and additions may be made therein and thereto, without parting from the spirit and scope of the present invention.

What is claimed is:

1. An electrolytic tilt sensor, comprising:
a containment envelope integrally fabricated from a polymer material having at least three apertures formed therein and defining an interior chamber;
an electrolytic solution partially filling the chamber; and
at least two electrodes, each electrode having an electrically active portion extending into the exterior of the envelope through a corresponding aperture.

2. The electrolytic tilt sensor of claim 1, wherein the containment envelope is integrally fabricated from piezoelectric polymers, conductive polymer, high performance polymers, and glass fiber reinforced polymer composites.

3. The electrolytic tilt sensor of claim 2, wherein the containment envelope is integrally fabricated from Polyetheretherketone, Polybutylene Terephthalate, Polycyclohexylenedimethylene Terephthalate, Polyphenylene Sulfide, Polyphenylsulfone, Acetal Copolymer, Liquid Crystal Polymer, Polytetrafluoroethylene, and/or Polyvinyl chloride

4. The electrolytic tilt sensor of claim 2, wherein the polymer material is a reinforced polymer composite.

5. The electrolytic tilt sensor of claim 1, wherein the containment envelope comprises a cap and a header, the cap defining an opening and the header sealingly engaging the opening.

6. The electrolytic tilt sensor of claim 5, wherein the apertures are located in the header.

7. The electrolytic tilt sensor of claim 5, wherein the cap and the header are welded to one another.

8. The electrolytic tilt sensor of claim 5, wherein the cap and the header are sealed by an adhesive.

9. A method of assembling an electrolytic tilt sensor, comprising steps of:
providing an integral polymer cap having an opening and interior surfaces defining a containment volume through polymer fabrication methods;
providing a header;
providing an electrolytic solution;
partially filling the containment volume with the electrolytic solution through the opening;
engaging the header with the opening; and
hermetically sealing the header to the cap.

10. The method of claim 9 wherein the polymer fabrication method is one of injection molding, CNC machining, and/or a 3D printing process.

11. The method of claim 9 further comprising the steps of inserting a plurality of electrode into apertures in the header.

12. The method of claim 11 wherein the header is fabricated from a polymer and is molded around the electrode to form the apertures in the header.

13. The method of claim 11 wherein the electrode is pressed into the header to form apertures in the header.

14. The method of claim 9 further comprising the steps of depositing a plurality of electrodes.

15. The method of claim 9 wherein the header is welded to the cap so that the containment volume is hermetically sealed.

16. The method of claim 10 wherein the header is adhered to the cap so that the containment volume is hermetically sealed.

17. The electrolytic tilt sensor of claim 1 wherein the shape of the tilt sensor is substantially cylindrical in a vertical direction.

18. The electrolytic tilt sensor of claim 1 wherein the shape of the tilt sensor is substantially cylindrical in a horizontal direction.
